(19) United States
(12) Patent Application Publication
(10) Pub. No.: US 2017/0357662 A1
(43) Pub. Date: Dec. 14, 2017

(54) CREATING AND USING PROFILES FROM SURVEILLANCE RECORDS

(71) Applicant: Verint Systems Ltd., Herzliya Pituach (IL)

(72) Inventors: Yaniv Knany, Holon (IL); Oded Cohen, Herzeliya (IL); Shahar Daliyot, Ramot Meir (IL)

(21) Appl. No.: 15/179,149

(22) Filed: Jun. 10, 2016

(51) Int. Cl. G06F 17/30; G06Q 10/10; G06Q 50/00; G06K 9/00; H04N 7/18

(52) U.S. Cl. CPC G06F 17/30117; G06F 17/30017; G06K 9/00771; H04N 7/181; G06F 17/30032; G06F 17/30035; G06Q 50/01; G06Q 10/105

(57) ABSTRACT

Systems and methods for monitoring an area with a variety of different-type sensors to obtain records that are related to create profiles are disclosed. The created profiles reveal relationships between sensed data items from the surveillance network. The profiles may be updated over time to edit, refine, and expand the understanding of these relationships. In addition, “normal” behaviors for profiles and/or relationships between profiles may be established and monitored.

### FIELD OF THE INVENTION

The present disclosure relates to surveillance systems and more specifically, to the creation and use of profiles from records gathered by sensors in the surveillance system.

### BACKGROUND

Surveillance systems provide a means for monitoring activities over a large area discreetly. These systems have become commonplace in today's society, which places a high value on security.

Traditional surveillance systems use a network of cameras positioned around an area to gather video, which can then be observed by security personnel in a central location. In recent years, the amount of surveillance data which must be observed has increased dramatically. This growth is due to an increase in the activities that must be observed for effective surveillance and also due to an expansion of the areas that must be monitored. In addition, an ever-increasing number of different sensors may be used for surveillance, which further increases the amount of available surveillance data.

Specialized sensors may be added to a video surveillance system to supplement video data. For example, sensors may be used for detecting/monitoring vehicles, mobile devices, faces, and/or access-point entries/exits. Much of the data collected by the different sensors is inherently related to an individual (i.e., a subject). Knowledge of these relationships is key in understanding more about the individual, the individual's behavior, and even the individual's relationships with other individuals. Therefore, a need exists for a surveillance system that can monitor an area with a variety of different sensors to create records and then analyze the records to find hidden relationships. Profiles (e.g., of individuals) may be created from data in the related records and then updated over time to edit, refine, and broaden the understanding of individuals. In doing so, additional knowledge regarding a profile's behavior and/or a profile's relationships (with other profiles) may also be derived.

### SUMMARY

Accordingly, in one aspect, the present disclosure embraces a method for creating profiles from data gathered using a surveillance system. The method includes surveilling an area with a plurality of sensors to obtain records of various types (i.e., record types). Each record includes sensed data corresponding to the record type. Each record also includes a date, time, and location corresponding to the sensed data. Records of different record types are related by correlating the date, time, and location of the records. Related records are then used to create profiles.

In an exemplary embodiment of the method, record types include vehicle records, mobile device records, employee records, and/or personal records. A vehicle record may include sensed data corresponding to a license plate number, a vehicle make, a vehicle model, and/or a vehicle color. A mobile device record may include sensed data corresponding to a media access control (MAC) address, an international mobile station equipment identity (IMEI) number, and/or an international mobile subscriber identity (IMSI) number. An employee record may include sensed data corresponding to a name and/or identification number. A personal record may include sensed data corresponding to a name, an address, and/or a facial image.

In another exemplary embodiment of the method, the method further includes updating previously created profiles by relating newly obtained records that at least partially match the sensed data in the previously created profiles. This process may be used to derive a profile behavior, and in another exemplary embodiment of the method, the method further includes the step of deriving a profile behavior based on the related records of the profile. A profile behavior may be, for example, a particular route travelled through an area and may include the speed and/or time that the route was travelled. Profiles behaviors may allow for profiles to be linked together, and in a possible embodiment, the method further includes the step of linking profiles together as companion profiles when their profile behaviors match. Profile behaviors may also allow “normal” behaviors to be defined, and in a possible embodiment, the method further includes the step of comparing a profile's behavior at one time to the profile's behavior at other times to determine a normal profile behavior.

In another exemplary embodiment of the method, the correlation of dates, times, and locations of different record types to relate the records may be accomplished by initially selecting a first record. Then, searching other records (i.e., records of other types) to find records that match the first record's date, time, and location. The records resulting from the search (i.e., the matching records) are added to a candidate list. Next, a subsequent record, which matches the sensed data of the first record, is selected. Then, a subsequent search of the records is executed to find records that match the subsequent record's date, time, and location. Records in the candidate list that are not found in the subsequent search are eliminated. This process of selecting records, executing searches, and deleting records from the candidate list repeats until only one record remains in the candidate list. The one remaining record is then related to the first and subsequent records.

In another aspect, the present disclosure embraces a surveillance system. The surveillance system includes a plurality of dfferent-type sensors that are arranged in different locations to gather sensed data. The surveillance system also includes a sensor management system that receives the sensed data from the plurality of sensors and creates records from the sensed data. Each record has assigned a particular record type that corresponds with the sensed data, and each record includes (i) sensed data from a sensor and (ii) a time/date/location corresponding to the sensed data. The surveillance system also includes a database that receives and stores records from the sensor management system. The surveillance system further includes a relations system that is communicatively coupled to the database. The relations system includes a processor that when configured by software (i) identifies relationships between records by correlating the time/date/location of records of different types, (ii) creates profiles based on the related records, and (iii) stores the profiles in the database.

In an exemplary embodiment of the surveillance system the plurality of sensors include a sensor to capture license plate numbers (LPNs).

In another exemplary embodiment of the surveillance system, the plurality of sensors include a sensor to capture a mobile device's media access control (MAC) address.

In another exemplary embodiment of the surveillance system, the plurality of sensors include a sensor to recognize faces.

In another exemplary embodiment of the surveillance system, the plurality of sensor include a sensor to read a badge or a card.

In another exemplary embodiment of the surveillance system, the relations system identifies relationships and creates profiles as a results of a search of the databased for sensed data.

In another exemplary embodiment of the surveillance system, the relations system identifies relationships and creates profiles automatically and periodically.

In another exemplary embodiment of the surveillance system, the relations system's processor is further configured by software to link profiles together by correlating data between profiles.

The foregoing illustrative summary, as well as other exemplary objectives and/or advantages of the disclosure, and the manner in which the same are accomplished, are further explained within the following detailed description and its accompanying drawings.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

FIG. 1 schematically depicts a surveillance system including a plurality of different-type sensors according to an embodiment of the present disclosure.

FIG. 2 is a flow chart of an exemplary process for creating profiles from surveillance system records according to an embodiment of the present disclosure.

FIG. 3 is a flow chart illustrating an exemplary process for relating records of different types according to an embodiment of the present disclosure.

FIG. 4 graphically depicts a subject's path over time through three locations of an area monitored by a surveillance system according to an embodiment of the present disclosure.

FIG. 5 graphically depicts an exemplary implementation of the processes of FIG. 2 and FIG. 3 according to an embodiment of the present disclosure.

FIG. 6 graphically depicts an exemplary graphical user interface for a surveillance system according to an embodiment of the present disclosure.

### DETAILED DESCRIPTION

The present disclosure embraces analyzing unstructured surveillance system data to discover relationships that may be used to create/update profiles, profile behaviors, and profile relationships. The profiles may be used for security (e.g., forensics, alarms, alerts, etc.) and/or commerce (e.g., customer service, worker compliance, etc.) and may be used in a variety of environments (e.g., airports, casinos, stores, city centers, etc.).

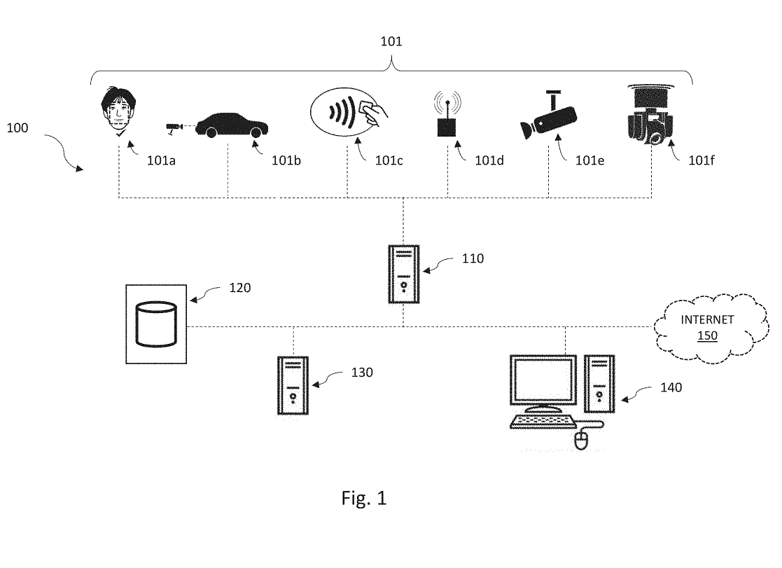

A schematic of exemplary surveillance system is shown in FIG. 1. The surveillance system 100 includes a plurality of sensors 101. The sensors 101 may be distributed around a monitored area (e.g., a parking lot, an airport, a warehouse, an office, etc.). The sensors may be fixedly positioned or may be temporarily positioned. All or some of the sensors 101 may be of different types. Possible sensors include (but are not limited to) facial recognition sensors 101a, license plate number (LPN) sensors 101b, card readers 101c, mobile device sensors 101d, fixed-mount cameras 101e, and pan-tilt-zoom (PTZ) cameras 101f.

Each sensor is functional to gather one or more sensed data elements. Records may be created to include the at least one sensed data element, the location of the sensor, and the date/time the sensed data was acquired. The sensors may transmit records or may transit sensor data (i.e., raw data) to a sensor management system (SMS) to create records. For record creation, the SMS may have access to sensor locations (e.g., stored in memory) and may have a time keeping system for establishing a common time shared by the sensors. The created records are assigned different record types corresponding to the sensed data (e.g., LPN data from an LPN sensor is stored in a vehicle record). Record types may include (but are not limited to) vehicle records, mobile device records, employee records, and personal records. The various sensors, records, and sensor data will be described in further detail below.

A facial recognition sensor 101a typically senses data used to create personal records. A personal record of a facial recognition sensor may include an image of a face. In addition to (or instead of) the face image, the facial recognition sensor may return data corresponding to the results of facial recognition (e.g., “John Doe”). The facial recognition sensor may include a camera and the processing/software sufficient for recognition. In some cases, however, the processing for recognition is located remotely (i.e., from the camera). For example, in a possible embodiment, a camera for facial recognition may be a camera 101e, 101f in the surveillance network. In this case, the image/video of the individual's face may be processed for recognition by a remote computer (e.g., the SMS 110) that receives the image/video. Further, the facial recognition may occur automatically or as directed by a user.

An LPN sensor 101b typically senses data used to create vehicle records. A vehicle record of an LPN sensor 101b may include a license plate number (e.g., “AAA-1234”), a location (“Parking lot 1, section AA”) and a date/time (e.g., “Feb. 14, 2016 22:14:11”). In some cases, LPN sensors 101b may also return additional sensed data elements. For example, the LPN sensor may sense data including (but not limited to) an image of the license plate, a vehicle color, and/a vehicle type (e.g., make/model).

A card reader sensor 101c typically senses data used to create employee records. An employee record of a card reader sensor 101c may include a card number, a time/date stamp, and a location (e.g., an entry/exit point). In addition, the card reader sensor may return employee name, employee number, and a result (e.g., access granted, access denied). The card reader sensor may be embodied in various ways (e.g., magnetic stripe reader, RFID, NFC, etc.). Card reader sensors 101c are typically located at access points in the surveillance area. Card reader sensors are typically known to an individual (i.e., a user must interact) but in some embodiments (e.g., RFID), the card reader sensor may operate without an individual's knowledge.

A mobile device sensor 101d typically senses data used to create mobile device records. A mobile device record of a mobile device sensor 101d may include information identifying a wireless device, such as a media access control (MAC) address, an international mobile station equipment identify (IMEI) number, and an international mobile subscriber identity (IMSI) number. Mobile device sensors typically include an antenna and radio frequency electronics for receiving wireless signals from mobile devices (e.g., cellular phones, WI-FI device, etc.). The mobile device sensor 101d may also include the processing necessary to demodulate wireless signals, decode the wireless signals, and extract the information identifying the wireless device.

The sensors 101 are communicatively coupled either directly or via a network to the SMS 110. In some embodiments, sensors may also communicate either directly or indirectly with other sensors in the surveillance system 100. For example, a mobile device sensor 101d may trigger a camera sensor 101e to take a photo whenever the mobile device sensor obtains a mobile device's identifier. The sensors may communicate over a variety of communication mediums (e.g., as coax, wireline, optical fiber, wireless, etc.), may use a variety of analog or digital formats (e.g., NTSC, PAL, RGB, MPEG, H.264, JPEG video, etc.), and may use one or more of a variety of communication protocols (e.g., WI-FI, Ethernet, TCP/IP, etc.).

The SMS 110 may communicate with the sensors 101 to exchange data or to control one or more sensors. For example, the SMS may receive records and/or sensed data, and may transmit controlling signals to one or more sensors (e.g., PZT camera 101f). As mentioned previously, the SMS 110 may create records using sensed data. This creation may require the SMS to add a time, date, and/or location to the sensed data. In addition, the SMS may create multiple records from sensor data. For example, multiple records may be created from a sensor that returns multiple sensed date elements (e.g., a LPN and a photo of a license plate). The SMS may be embodied as server computer that has the processing/software necessary to interact with the sensors 101 and with other elements/systems the surveillance system 100.

As shown in FIG. 1, the SMS 110 is communicatively coupled (i.e., either directly or via a network) to other systems 120, 130, 140 in the surveillance system 100. In addition, the SMS 110 may communicate with other surveillance systems or databases via the internet 150 so that interaction with several systems may be localized despite large geographic separation. The systems 110,120,130,140 may communicate over a variety of communication mediums (e.g., as coax, wireline, optical fiber, wireless, etc.) use one or more of a variety of communication protocols (e.g., WI-FI, Ethernet, TCP/IP, etc.).

The SMS may communicate with one or more a monitoring stations 140. A monitoring station is typically a computer that includes hardware (e.g., display, mouse, keyboard, etc.) for user interaction and processing for running management software. The management software allows a user to interact with the sensors 101 as well as a database 120 (e.g., via a graphical user interface). For example, the user may control aspects of the surveillance system such as data gathering (e.g., recording), data visualization (e.g., playback), and analysis (e.g., searching).

The SMS 110 may also communicate with a database 120. The database (i.e., datacenter) may comprise a variety of communication, power, and storage systems to store and secure data. The database 120 may store all records obtained from the surveillance system, and may serve the stored records in response to a search.

Due to the limited structure of the records stored in the database 120, a simple search for sensed data may not reveal information in an effective way. For example, a search for a license plate number may return all records containing the license plate number, but often it is information about the driver that is desired. To obtain this information, relationships must be found between records. This is accomplished by the surveillance system's relations system 130.

The relations system 130 is a computing system configured (by software) to analyze the records stored in the database 120 to determine relationships. This analysis may be performed in real time (e.g., as records are recorded), periodically (e.g., after the count of records grows by an incremental amount or after a period), or as a result of user input (e.g., a search for a record). The relations system 130 is configured by software to create/update profiles based on related records. The general process for creating/updating profiles is described below.

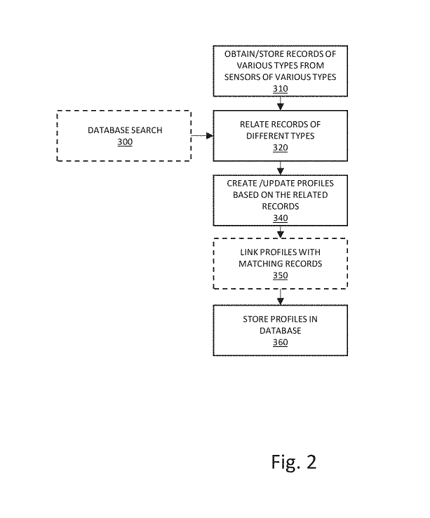

An exemplary process for creating profiles from data gathered using the surveillance system is shown in FIG. 2. As described previously, the surveillance system obtains records of various types from the sensors of various types 310 and stores these records in the database 120. One or more records may be obtained from from the database for analysis 300. For example, the records obtained may be the result of a search, and may include all records that match this search criterion 300. These returned records be of the same type (e.g., all a vehicle records) but each may have a different time/date/location. The time/date/location of each of these records may be used to search for other records (i.e., records of other types) that match time/date/location 320 to determine a relationship.

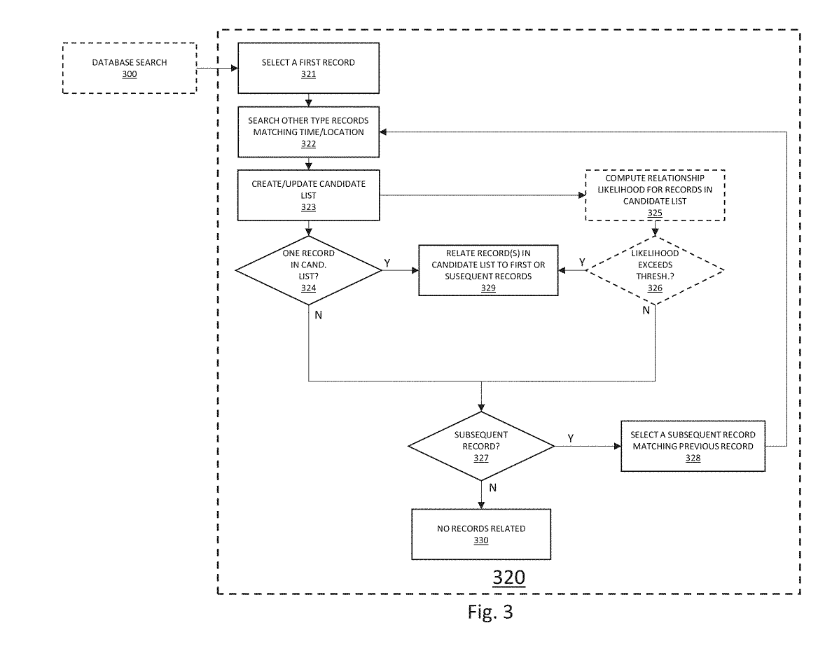

An exemplary implementation of the step of relating records 320 is shown in FIG. 3. From the set of same-type records returned from the search 300, a first record is selected 321. Records of types other than the first record are searched using the first records time/date/location as the search criterion. The records resulting from this search are used to create a candidate list of records 323. The candidate list having multiple records may be refined by looking at a subsequent record (i.e., a second record from the set of same-type records) 324, 327, 328. Using the subsequent record's time/date/location as a search criterion, other records (records of other types) are search for matching time/date/location 322. The other records matching the time/date/location are compared to the candidate list. The candidate list is updated to include only records that were also found the first search 323. In this way, the candidate list is refined (i.e., the number of candidates is reduced). This process continues until only one record remains in the candidate list 324. This remaining record is then related to first and subsequent records 329.

FIG. 3 represents a single embodiment for relating records—some variations exist. For example, if the initial search criteria 300 returns a small set of records, it may not be possible to winnow the candidate list down to a single record, even after analyzing all records. In this case, the computed relationship likelihood 325 may be used to relate the remaining records in the candidate list to the first (and subsequent) same-type records. For example, if the relationship likelihood meets or exceeds a threshold 326, then the records may be related, despite the fact the more than one record appears in the candidate list. In some cases, it may be impossible to relate records 330 conclusively. In these cases, the candidate records may be returned (e.g., via a GUI) with a message that the records were not related. For example, a candidate list including measurements of relationship likelihood may be returned with a message that no records were related due to lack of data. A user may be prompted analyze the results to determine if a relationship is suitable, and if suitable, to manually relate the records.

As shown in FIG. 2, profiles may be created/updated 340 after the records are related 320. Profiles include data from related records. For example, a profile may include a MAC address from a mobile-device record and an employee name from a related employee record. Additional information may be added to profiles as it becomes available. For example, an LPN record is discovered to relate to a mobile device record of a MAC address that is already in a profile, the LPN may be added to the profile. In this way, profiles may updated and expanded over time.

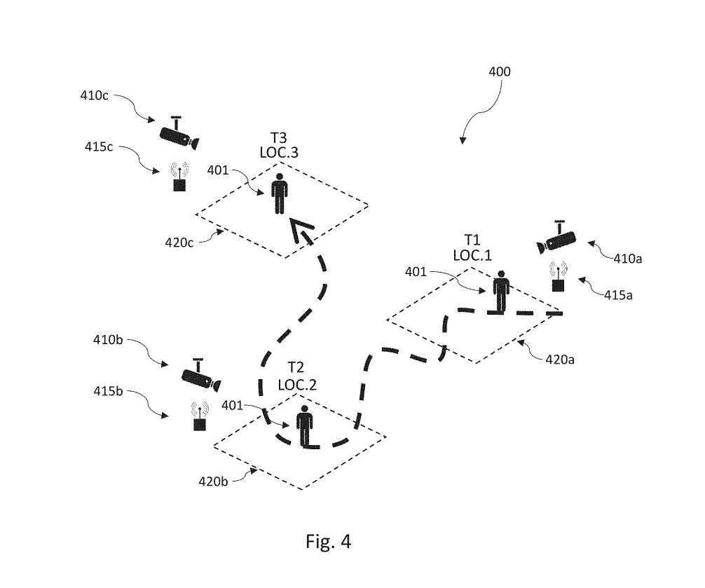

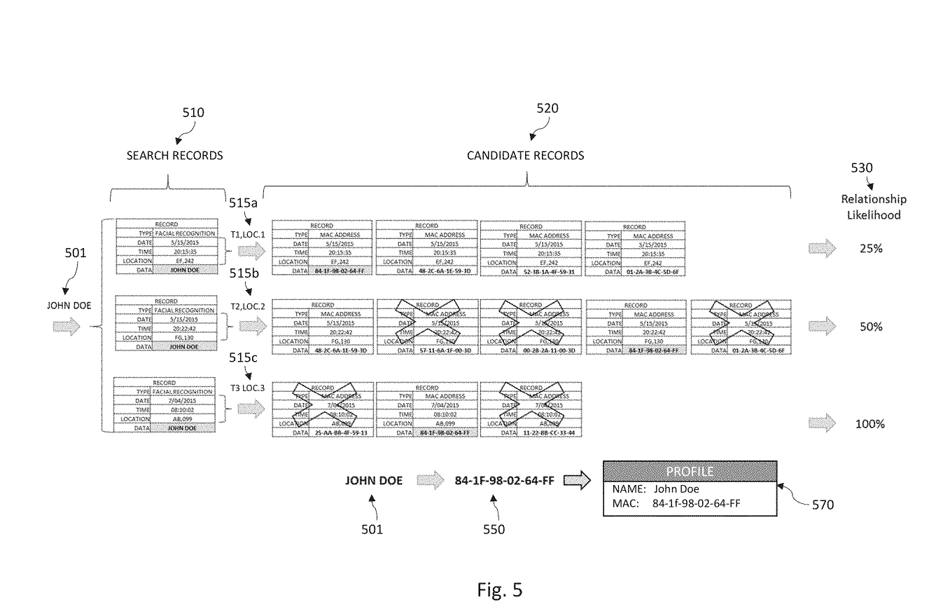

An exemplary implementation of the profile creation process is illustrated in FIGS. 4, 5. A subject 401 moving through three locations 420a, 420b, 420c in an area 400 monitored by a surveillance system is illustrated in FIG. 4. The subject moves along a route (i.e., dotted line) and reaches location 1 (LOC.1) 420a at a first time (T1). The subject 401 continues to move to a second location (LOC.2) 420b at a second time (T2) and to a third location (LOC.3) 420c at a third time (T3). The first location is monitored by (i) a facial recognition sensor 410a which recognizes the subject's face as “John Doe” and (ii) a mobile device sensor (e.g., a MAC catcher) 415a, which captures mobile device information. Likewise, the second and third locations are monitored by facial recognition sensors 410b, 410c and mobile device sensors 415b and 415c. Records are created by each sensor for each location and for each time and are stored in the database.

As shown in FIG. 5, a search for the subject (i.e., “John Doe”) yields three records at three times/locations 515a, 515b, 515c. The database is searched for other records (i.e., mobile device records—MAC address) that match the first time/location 515a. This search results in four candidate records. In other words, four mobile devices were detected in LOC.1 at T1. These candidate records 520 are entered into a candidate list. The database is then searched for other records that match the second time/location. This search results in five records; however, only two of these records match the records in the candidate list. The candidate list is updated to include only the two records that are present at both locations and at both times. Finally, the database is searched for other records that match the third time/location. This search results in three records, and the records that do not match the candidate list are eliminated. As a result, only one record remains in the candidate list (i.e., matches all times/locations). During this process the likelihood that the mobile device record is related to the facial recognition record grows 530. The sensed data from the facial recognition record (i.e., “John Doe”) 501 may be combined with the sensed data from the mobile device record. (i.e., “84-1F-98-02-64-FF”) to create a profile 570. The profile shows the relationship between the records (i.e., “John Doe” uses device “84-1F-98-02-64-FF”).

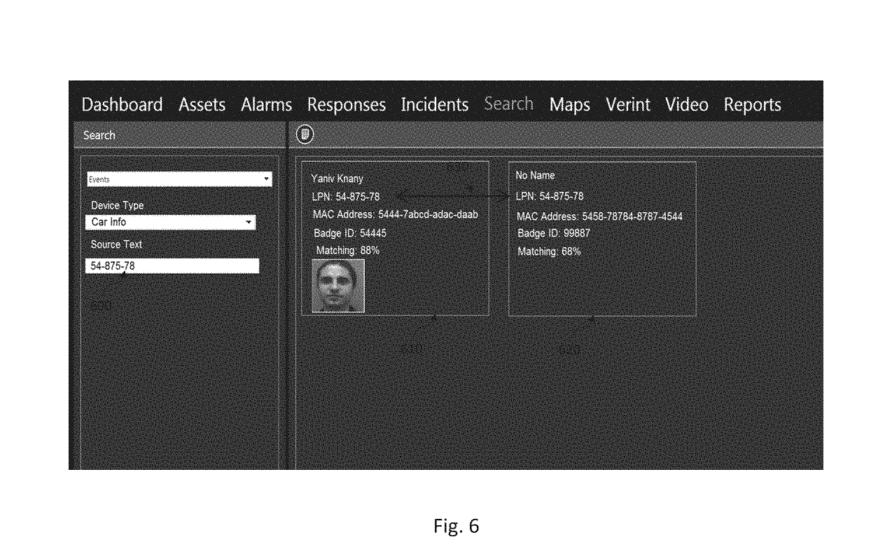

Profiles may also be linked if they are created from matching records 350. For example, two profiles of individuals may be related to the same LPN when they travel together in the same vehicle. The link may be stored with profiles, and may be used in relating subsequently obtained records (e.g., the calculation of the relationship likelihood). Links may be expanded over time to develop networks of individuals. The profiles are stored in the database 360 and can be used to aid in forensics, improve database search time, and improve intelligence gathering. Results of an exemplary search for sensed data is shown in FIG. 6. Here, a search for a LPN 600 results in two returned profiles 610, 620. The profiles are linked 630 by the common LPN.

After profiles are established, behaviors (e.g., “normal” behaviors) may be understood. For example, it may be observed that an individual linked to a MAC address may repeatedly take the same route through an area. It may be also observed that this route may be travelled over a period that is similar for each journey. This route/travel-time may be stored with the profile as a normal behavior. When an individual associated with a profile deviates from normal behavior, then an alert may be created.

In the specification and/or figures, typical embodiments have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation. Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not.

1. A method for creating profiles from data gathered using a surveillance system, the method comprising:
surveilling an area using a plurality of sensors to obtain records, wherein each record is one of a plurality of record types, and wherein each record includes (i) sensed data corresponding to the record type and (ii) a date, a time, and a location corresponding to the sensed data;
relating records of different record types by correlating the date, time, and location of the records;
creating profiles based on the related records.

2. The method according to claim 1, wherein the plurality record types include a vehicle record, a mobile device record, an employee record, and/or personal record.

3. The method according to claim 2, wherein the sensed data for a vehicle record is a license plate number, a vehicle make, a vehicle model, and/or a vehicle color.

4. The method according to claim 2, wherein the sensed data for a mobile device record is a media access control (MAC) address, an international mobile station equipment identity (IMEI) number, and/or an international mobile subscriber identity (IMSI) number.

5. The method according to claim 2, wherein the sensed data for an employee record is a name and/or an identification number.

6. The method according to claim 2, wherein the sensed data for a personal record is a name, an address, and/or a facial image.

7. The method according to claim 1, further comprising:
updating previously created profiles by relating obtained records that at least partially match the sensed data in the previously created profiles.

8. The method according to claim 7, further comprising:
deriving a profile behavior based on the related records of a profile.

9. The method according to claim 8, wherein the profile behavior is a particular route through an area at a particular time, and at a particular speed.

10. The method according to claim 9, further comprising:
linking profiles together as companion profiles if the profile behaviors for the profiles match.

11. The method according to claim 8, further comprising:
comparing a profile's profile behavior at a first time to the profile's profile behaviors at other times to determine a normal profile behavior.

12. The method according to claim 1, wherein the relating records of different record types by correlating the date, time, and location of the records, comprises:
selecting a first record;
executing a first search of records to find records that match the first record's date, time, and location;
adding the matching records to a candidate list;
selecting a subsequent record, wherein the subsequent record's sensed data matches the first record's sensed data;
executing a subsequent search of records to find records that match the subsequent record's date, time, and location;
deleting records from the candidate list that were not also found in the subsequent search;
repeating the process of selecting subsequent records, executing subsequent searches, deleting records from the candidate list, and updating the relationship likelihood until one record remains in the candidate list, and
relating the remaining record in the candidate list to the first and subsequent records.

13. A surveillance system, comprising:
a plurality of sensors arranged in different locations and gathering sensed data, wherein the plurality of sensors comprises sensors of different types;
a sensor management system receiving sensed data from the plurality of sensors and creating records from the received sensed data, wherein each record includes (i) the sensed data from a sensor and (ii) a date, a time, and a location corresponding to the sensed data, and wherein each record is assigned a particular record type that corresponds with the sensed data;
a database receiving and storing the records from the sensor management system; and
a relations system communicatively coupled to the database, wherein the relations system includes a processor configured by software to:
identify relationships between records of different types by correlating the date, time, and location of the records of different types, and
create profiles based on the related records, the profiles stored in the database.

14. The surveillance system according to claim 13, wherein the plurality of sensors include a sensor to capture license plate numbers.

15. The surveillance system according to claim 13, wherein the plurality of sensors include a sensor to capture a mobile device's media access control (MAC) address.

16. The surveillance system according to claim 13, wherein the plurality of sensors include a sensor to recognize faces.

17. The surveillance system according to claim 13, wherein the plurality of sensors include a sensor to read a badge or a card.

18. The surveillance system according to claim 13, wherein the relations system identifies relationships and creates profiles as a result of a search of the database for sensed data.

19. The surveillance system according to claim 13, wherein the relations system identifies relationships and creates profiles automatically and periodically.

20. The surveillance system according to claim 13, wherein the relations system's processor is further configured by software to:
link profiles by correlating data between profiles.
